(19) United States
(12) Patent Application Publication
(10) Pub. No.: US 2004/0079539 A1
(43) Pub. Date: Apr. 29, 2004

(54) Three-point hitch adapter for motor vehicles, ATV's and lawn tractors

(76) Inventor: Robert A. Schmidt, Lapeer, MI (US)

Correspondence Address: Robert A. Schmidt, 389 W. Hunters Creek Rd., Lapeer, MI, 48446, US

(21) Appl. No.: 10/402,309

(22) Filed: Mar. 31, 2003

Related U.S. Application Data
(60) Provisional application No. 60/421,532, filed on Oct. 28, 2002.

(51) Int. Cl. A01B 59/043

(52) U.S. Cl. 172/439

(57) ABSTRACT

A motor vehicle, ATV and lawn tractor three-point hitch adapter that provides attachment of standard agricultural category one three-point hitch implements such as scraper blades, landscaping rakes or box blades. The adapter comprises of a tube that interfaces with the motor vehicle hitch receptacle, a bracket that interfaces with the category one implement's two pivot post attachment points, and a winch that interfaces with the category one implement's upper attachment point for raising and lowering the implement. The electric winch is connected to the vehicle battery and contains a switch for controlling up and down movement of the implement by the vehicle operator. The motor vehicle adapter can be also used with all-terrain vehicles and lawn tractors when a wheel assembly and hitch assembly are added. The wheel assembly comprises of a welded tube assembly that is bolted to the motor vehicle adapter, an axle, two wheels and cotter pins to hold the wheels in place. The hitch assembly comprises of a tube that slides over the motor vehicle tube that interfaces with the motor vehicle receptacle. It also comprises of a hitch that is bolted to the ATV or lawn tractor hitch interface. A hitch pin and cotter pin are used to attach the hitch assembly to the motor vehicle adapter assembly.

### CROSS-REFERENCED TO RELATED APPLICATIONS

This application claims the benefit of provisional patent application No. 60/421,532, filed Oct. 28, 2002 by Robert A. Schmidt.

### BACKGROUND OF THE INVENTION

1. Field of the Invention

This invention relates in general to vehicle mounted scrapers and in particular to a novel hitch mounted adapter allowing attachment of agricultural category one three-point hitch implements to motor vehicles, ATV's and lawn tractors.

2. Dicussion of Prior Art

There are many types of motor vehicle attachment methods for scraper blades and the like. These attachments allow light trucks and the like to clear snow or perform grading work. Generally snowplows are mounted on the front of the vehicle and have hydraulic means for controlling the blade height and angle. These snowplows are expensive because they have unique mounting hardware for particular vehicle platforms. They also require attachment to the front frame of the vehicle that makes assembly and disassembly time consuming and difficult. Another disadvantage of this mounting configuration is that snow coming off the top of the blade can obstruct the driver's vision. This arrangement of the blade can also obstruct the vehicle headlights requiring the addition of lights on the top of the blade that increases the total cost.

Another means of adding a scraper blade to a vehicle is by attaching it to the rear of the vehicle. This eliminates some of the above noted problems of the front mounted blade. The vehicle headlights are not obstructed, snow coming off of the blade will not obstruct the driver's vision, and most vehicles have a hitch receiver for mounting hardware for attachment of a blade.

In order to provide background information so that the invention may be completely understood and appreciated in its proper context, reference is made to a number of prior art patents. U.S. Pat. No. 4,215,496 of Wehr shows a typical front mounted snowplow blade. These systems require complex brackets to attach to the front of the vehicle and also require an additional set of headlights because the blade obstructs the vehicle headlights. The brackets need to be designed for specific vehicle frame configurations requiring additional design work and product proliferation resulting in increased cost per unit.

U.S. Pat. Nos. 4,403,432 and 5,595,007 of Biance show a rear mounted scraper blade that adapts to the motor vehicle's trailer hitch receptacle. The disadvantage of this design is that it is designed around a particular scraper blade design. It does not use existing agricultural scraper blades that are produced in higher volume and therefore the total design offers less flexibility and more cost.

U.S. Pat. No. 4,369,590 of Miller shows a rear mounted blade assembly that is mounted directly to the rear frame of the vehicle. This has similar disadvantages to the front mount snowplow in that unique brackets would be required for different vehicle frame designs. It also has the same disadvantages of Biance in that the scraper blade is a unique design and therefore offers less flexibility and more cost.

There are also many types of ATV and lawn tractor attachment methods for scraper blades and the like. These attachments allow ATV's and lawn tractors to clear snow or perform grading work. Generally snowplows are mounted on the front of the ATV or lawn tractor and the blade height is either controlled manually or by an electric winch. These snowplows are expensive because they have unique mounting hardware for the particular application and can only be used for plowing snow. They also require attachment to the frame of the ATV or lawn tractor that makes assembly and disassembly time consuming and difficult.

In order to provide background information so that the invention may be completely understood and appreciated in its proper context, reference is made to a number of prior art patents related to ATV and lawn tractor products. U.S. Pat. No. 6,269,557 of Henks shows a typical front mounted snowplow blade on an ATV. These systems require complex brackets to attach to the front of the ATV and can only be used to plow snow. The brackets need to be designed for specific ATV frame configurations requiring additional design work and product proliferation resulting in increased cost per unit.

U.S. Pat. No. 5,064,338 of Lawrence shows an implement mounting apparatus for tractors and mowers. This configuration has the similar disadvantages in that unique mounting hardware is required for various lawn mower frame designs. Also the attachments are designed specifically for the mounting apparatus instead of being able to accept standard agricultural attachments that are produced in higher volume and therefore the total design offers less flexibility and more cost.

U.S. Pat. No. 5,988,294 of Hubscher shows a cultivator for towing behind an ATV. This does not require special mounting hardware but has similar disadvantages to Lawrence in that the cultivator and accessories are designed specifically for the mounting apparatus instead of being able to accept standard agricultural attachments that are produced in higher volume and therefore the total design offers less flexibility and more cost.

U.S. Pat. No. 5,746,275 of Cross et al. shows a three-point hitch for an ATV. This configuration is attached directly to the rear of the ATV and accepts smaller category 0 farm implements. The disadvantage of this configuration is all of the weight of the implement when raised is on the rear axle of the ATV. Also, since it is attached directly to the rear of the ATV, the assembly needs to be designed for specific ATV frame configurations requiring additional design work and product proliferation resulting in increased cost per unit.

The present invention is intended to overcome the above described shortcomings of conventional motor vehicle front mounted snowplows and rear mounted scrapers. It is also intended to overcome the above described shortcomings of conventional ATV and lawn tractor utility accessory attachment methods

### SUMMARY OF THE INVENTION

A hitch mounted adapter is provided which mates with a standard square motor vehicle trailer hitch receptacle, and also can be hitched to lawn tractors and all-terrain vehicles to provide attachment of standard agricultural category one three point hitch implements such as scraper blades, landscape rakes or box blades. The motor vehicle adapter comprises of a tube that interfaces with the motor vehicle hitch receptacle, a bracket that interfaces with the category one implement's two pivot post attachment points, and a winch that interfaces with the category one implement's upper attachment point for raising and lowering the implement. The electric winch is connected to the vehicle battery and contains a switch for controlling up and down movement of the winch by the vehicle operator.

The present invention further includes a slot in the hitch adapter pivot point bracket to allow easy attachment of the implement's post attachment points. A plate is then bolted onto the bracket to keep the implement from coming out of the slot during operation. The hitch adapter is designed to withstand the forces exerted by the implement during operation.

The motor vehicle adapter can be also used with all-terrain vehicles and lawn tractors when a wheel assembly and hitch assembly are added. The wheel assembly comprises of a welded tube assembly that is bolted to the motor vehicle adapter, an axle, two wheels and cotter pins to hold the wheels in place. The hitch assembly comprises of a tube that slides over the motor vehicle tube and interfaces with the motor vehicle receptacle. It also comprises a hitch that is bolted to the ATV or lawn tractor hitch interface. A hitch pin and cotter pin are used to attach the hitch assembly to the motor vehicle adapter assembly.

It is the object of the present invention to provide an adapter for a motor vehicle which connects to the trailer hitch receptacle and provides an attachment point for standard agricultural three-point hitch implements such as scraper blades, landscape rakes and box blades.

Another object of the invention is the provision of such an adapter to be conveniently secured to and removed from the vehicle in a very rapid manner.

Another object of the invention may be noted the provision of such an adapter which utilizes a remotely controlled mechanism for raising and lowering of the implement; which is relatively easily manufactured and assembled; which is extremely rugged, durable and long lasting in operation.

Another object of the invention is the provision of such an adapter to utilize a wheel and hitch assembly that allows the adapter to be used with all-terrain vehicles and lawn tractors.

These and other objects, features and advantages will become readily apparent from the following description and accompanying sheets of drawings.

### BRIEF DESCRIPTION OF THE DRAWINGS

FIG. 1 is a perspective view of a motor vehicle equipped with a rear mounted category one agricultural scraper blade attached to a three-point hitch adapter made in accordance with the present invention;

FIG. 2 is a perspective view of an ATV equipped with a rear mounted category one agricultural scraper blade attached to a three-point hitch adapter made in accordance with the present invention;

FIG. 3 is a perspective view of the hitch adapter.

FIG. 4 is a side elevation view of a motor vehicle equipped with a rear mounted category one agricultural scraper blade showing the up and down positions of the blade.

FIG. 5 is a side elevation view of an ATV motor vehicle equipped with a rear mounted category one agricultural scraper blade showing the up and down positions of the blade.

### DESCRIPTION OF THE PREFERRED EMBODIMENTS

The main sections and parts of the invention are described on the basis of the indicative example below wherein the item numbering corresponds to the drawing.

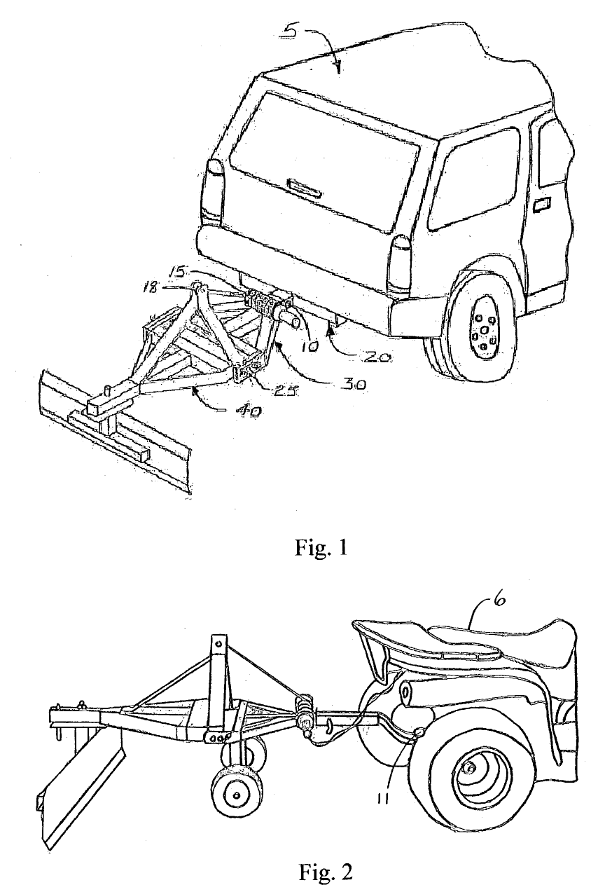

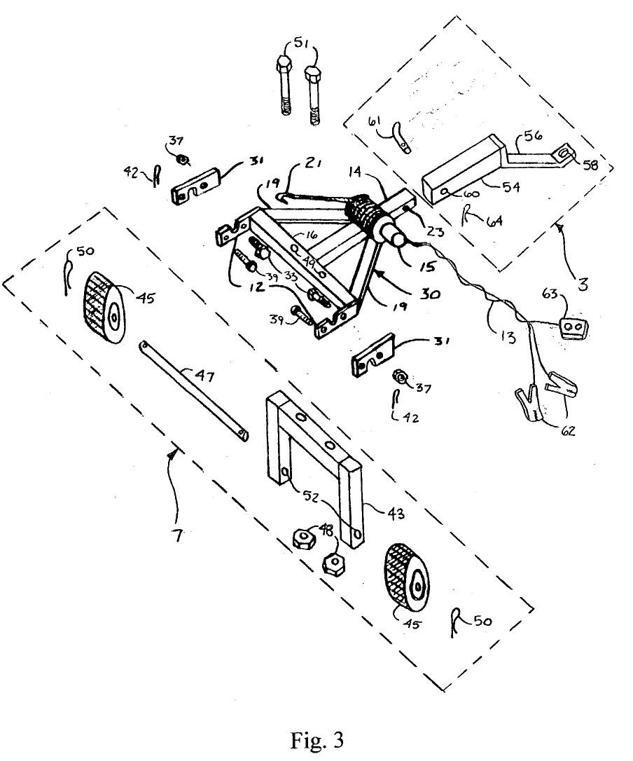

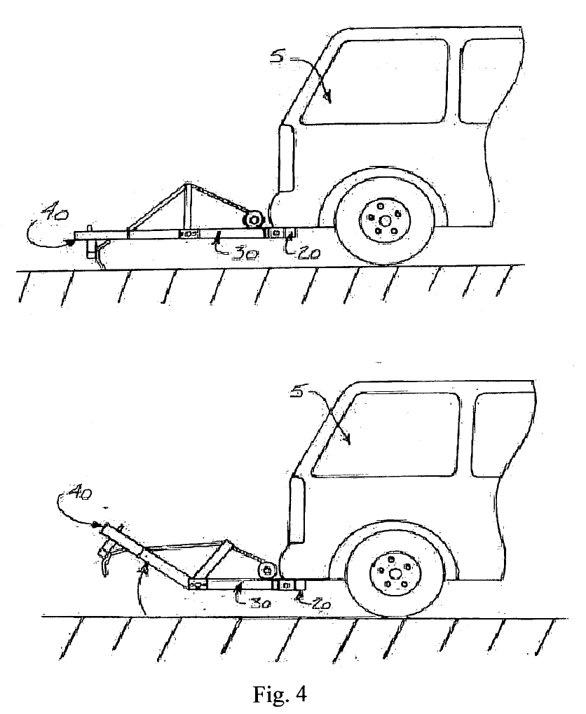

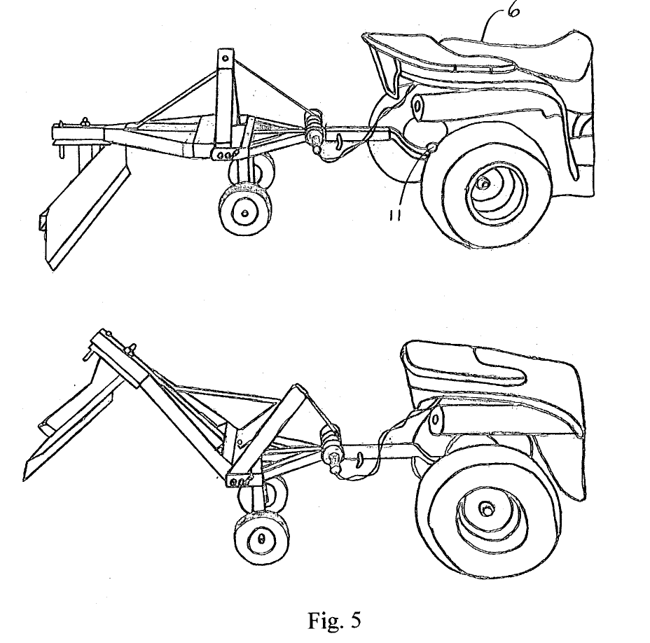

A three-point hitch adapter 30, made in accordance with the present invention, is shown in FIG. 3. The adapter 30 is attached to the motor vehicle 5 at its hitch 10 and is held in place with a pin as would a typical ball hitch receptacle. The adapter 30 allows the attachment of an agricultural category one implement such as a blade scraper 40 as shown in FIG. 1.

The wheel assembly 7 and hitch assembly 3 is attached to adapter 30 so that it can be hitched to a lawn tractor or ATV 6 at its hitch 11. This allows the attachment of an agricultural category one implement such as a blade scraper 40 as shown in FIG. 2.

The adapter 30, consists of a square tube 14 that is welded or otherwise connected to an angle iron brace 16. The tube 14 slides into the vehicle hitch receptacle 10 and is held in place with a pin through the hole 23. Hole 23 is sized identical to a typical ball hitch receptacle pin interface. The brace 16 is supported by two angle iron brackets 19 that are welded or otherwise attached to the brace 16 and the tube 14. Brace 16 is sized to interface with the standard category 1 agricultural implement width.

The electric winch 15 is bolted to the tube 14 and its hook 21 is attached to the category one implement at 18. When the electric winch 15 is operated, it pulls the category one hitch point 18 towards the winch causing the implement to pivot at the pivot post 25 resulting in the implement being raised as shown in FIGS. 4 & 5. Tube 14 is sized so that when the implement is raised, point 18 will not come in contact with the vehicle. It also cannot be too long or it will allow the implement 40 to put too much cantilever load on the vehicle 5 when the implement is in the up position. The winch contains a wire harness 13 that contains battery hook-up leads 62 for powering the winch and a switch 63 for controlling up and down movement of the implement 40.

A pivot interface bracket 12 is welded or otherwise attached to the brace 16 and has a slot that interfaces with the category 1 implement pivot post 25. Plate 31 is secured with a bolt 33 and lock nut 37 allowing it to pivot onto post 25. The plate 31 is retained by a stud 39 and cotter pin 42. The plate 31 insures that the post 25 does not come out of the slot in the bracket 12 during operation.

A wheel assembly 7 is made up of a welded tube or otherwise fabricated frame 43 that is bolted onto the adapter 30 with bolts 51 and nuts 48 thru holes 49. An axle 47 is assembled to welded tube frame 43 thru holes 52. The wheels 45 are assembled onto the axle 47 and retained with cotter pins 50.

A hitch assembly 3 is made up of a tube 54 that slides over tube 14 and is attached to adapter 30 with a pin 61 thru holes 60 and 23, and retained with cotter pin 64. A hitch 56 is welded or otherwise attached to tube 54 and attaches to the ATV or lawn tractor 6 thru hole 58.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A three point hitch adapter for motor vehicles comprising:
a tube that is sized to mate with the motor vehicle hitch receptacle;
a brace that is attached to the tube that provides a means for attachment of three point hitch implement pivot posts;
a bracket attached to each end of the tube and brace for structural support;
an electric winch that is mounted to the tube and whose cable is attached to the three point hitch implement top link to provide a means of raising and lowering the implement;
a wire harness that is attached to the electric winch that is of sufficient length to route into the vehicle compartment for power hook-up and vehicle operator control of the winch.

2. A three point hitch adapter for ATV's and lawn tractors comprising:
a tube that is sized to mate with the motor vehicle hitch receptacle;
a brace that is attached to the tube that provides a means for attachment of three point hitch implement pivot posts;
a bracket attached to each end of the tube and brace for structural support;
an electric winch that is mounted to the tube and whose cable is attached to the three point hitch implement top link to provide a means of raising and lowering the implement;
a wire harness that is attached to the electric winch that is of sufficient length to route into the vehicle compartment for power hook-up and vehicle operator control of the winch.
A wheel assembly that is attached to the brace that positions the brace vertically and supports the load when the implement is raised;
A hitch assembly that is attached to the tube that positions the tube horizontally and provides attachment means to the ATV or lawn tractor hitch.
